(19) United States
(12) Patent Application Publication
(10) Pub. No.: US 2011/0146632 A1
(43) Pub. Date: Jun. 23, 2011

(54) System and Method for Improving Combustion Quality in Diesel Engine

(76) Inventor: George Alfred Legg, Hico, WV (US)

(21) Appl. No.: 12/969,079

(22) Filed: Dec. 15, 2010

Related U.S. Application Data
(60) Provisional application No. 61/287,906, filed on Dec. 18, 2009.
(60) Provisional application No. 61/288,012, filed on Dec. 18, 2009.

(51) Int. Cl. F02M 15/00

(52) U.S. Cl. 123/542

(57) ABSTRACT

The present application includes an air intake system for cooling charged air prior to entering one or more cylinders of a diesel engine. The air intake system may include a housing that includes a hydronic intake air manifold comprised of tubing and fins having a pair of ports further comprising a hydronic water cooling coil having a pair of ports, a belt-driven centrifugal pump having a plurality of ports with a reservoir containing a proportional mixture of distilled water and ethylene glycol antifreeze. The present application may further include an air intake method for cooling charged air prior to entering one or more cylinders of a diesel engine. The method includes drawing air into an eductor through an air filter, wherein the eductor is coupled to the intake system; moving air into an intake air manifold where a proportional mixture of distilled water and ethylene glycol antifreeze absorbs heat; pumping the mixture through a coil by a centrifugal pump, the mixture being located in a reservoir operably connected to the pump; and releasing the heat into the air via a heat exchanger to cool charged air prior to an intake port of one or more cylinders of a diesel engine. The present application may further include a diesel engine used in the air intake system for cooling charged air, the diesel engine having a displacement due to a radial distance between a crankshaft center and a rod journal center.

### CROSS REFERENCE TO RELATED APPLICATIONS

The present application claims the benefit of U.S. Provisional Application Nos. 61/287,906 and 61/288,012, filed Dec. 18, 2009.

### BACKGROUND

The present application generally relates to a system and method for improving combustion quality in a diesel engine. The present application more particularly relates to an air intake cooling system and method for improving the combustion quality in a diesel engine and the diesel engine itself used in the system.

The two biggest issues for the efficiency in a diesel engine are speed and temperature of air entering the piston cylinders. The combustion ratio can, in turn, affect the combustion of fuel. Therefore, an effective means of cooling the charged air as well as a longer piston stroke is needed to maintain overall diesel engine efficiency.

In a conventional cooling system of a diesel engine, a charge air cooler is used. A charge air cooler cools the diesel engine intake air after the intake air has passed through a gas compressor, but before the air passes to the piston cylinder. The charge air cooler is typically fitted between a turbocharger and an air manifold.

In a conventional diesel engine, waste heat from the exhaust is used within the turbocharger to compress air, which increases the efficiency of the engine by allowing more air in a short time into the turbocharger ports. At the outlet of the turbocharger, the air is completely compressed, but the temperature of the air also increases, which reduces the density of the air entering the cylinders, thereby reducing the engine's efficiency. The charge air cooler reduces the temperature of the charged air at the outlet of the turbocharger. This has the effect of increasing the air density of the charged air, allowing a larger mass of air to be compressed inside of the engine cylinder for more complete combustion of the fuel.

However, conventional charge air coolers do not reduce the charged air or the exhaust gas temperature enough, leading to inefficient fuel combustion. In addition, turbochargers take up more space within the system and move gases slower than other more efficient devices. The higher compression temperature also places more stress on the piston and the piston rings.

Complete combustion of fuel can also be affected by the piston speed in a diesel engine. Besides air temperature, piston speed is an important parameter for diesel engines. Piston speed on the compression stroke is important to obtain ignition heat to combust the fuel. Piston speed is the rate at which the piston travels up and down within the cylinder. It is a function of stroke and RPM. At higher RPMs, the piston speed increases. The longer the stroke, the faster the piston has to travel to cover the distance of its stroke during the engine's revolution.

Conventionally, piston speed is increased by raising the limit of revolutions allowed. However, this can cause the weight of the piston on the upstroke to create a lot of momentum and load on the small end of the rod, wrist pin, and wrist pin eyelets of the piston. If the RPMs go too high, the wrist pin eyelets will be pulled out of the piston. Mechanical damage is not the only concern. The intake air will be traveling too fast for it to be efficiently cooled. This will lower the cylinder pressure due to a decrease in volume of air entering the cylinders. Thus, an excessive and wasteful number of injection cycles will occur causing the engine to overheat.

### SUMMARY

The present application relates to an air intake system for cooling charged air prior to entering one or more cylinders of a diesel engine. The air intake cooling system may include a hydronic intake air manifold comprising tubing and fins having a pair of ports further including a hydronic water cooling coil having a pair of ports and a belt-driven centrifugal pump having a plurality of ports with a reservoir containing a proportional mixture of distilled water and ethylene glycol antifreeze.

The present application also relates to an air intake method for cooling charged air prior to entering one or more cylinders of a diesel engine. The method includes drawing air into an eductor through an air filter, wherein the eductor is coupled to the exhaust system; moving air into an intake air manifold where a proportional mixture of distilled water and ethylene glycol antifreeze absorbs heat; pumping the mixture through a coil by a centrifugal pump, the mixture being located in a reservoir operably connected to the pump; and

releasing the heat into the air via a heat exchanger to cool charged air prior to entering one or more cylinders of a diesel engine.

The present application further relates to a diesel engine used in the air intake system for cooling charged air, the diesel engine having a displacement due to a radial distance between a crankshaft center and a rod journal center.

### BRIEF DESCRIPTION OF THE DRAWINGS

The present disclosure will become more fully understood from the following detailed description, taken in conjunction with the accompanying figures, wherein like reference numerals refer to like elements, in which:

FIG. 1 is a perspective view of a hydronic water cooling coil, according to an aspect of the present disclosure;

FIG. 2 is a perspective view of a centrifugal pump used in the air intake system, according to an aspect of the present disclosure;

FIG. 3 is a perspective view of an air intake manifold containing the hydronic water cooling coil, and various ports to cylinders of the engine, according to an aspect of the present disclosure; and

FIG. 4 is a flow diagram of a method for cooling charged air prior to entering one or more cylinders of a diesel engine, according to an aspect of the present disclosure.

Before turning to the figures, which illustrate certain embodiments in detail, it should be understood that the application is not limited to the details or methodology set forth in the description or illustrated in the figures. It should also be understood that the terminology is for the purpose of description only and should not be regarded as limiting.

### DETAILED DESCRIPTION

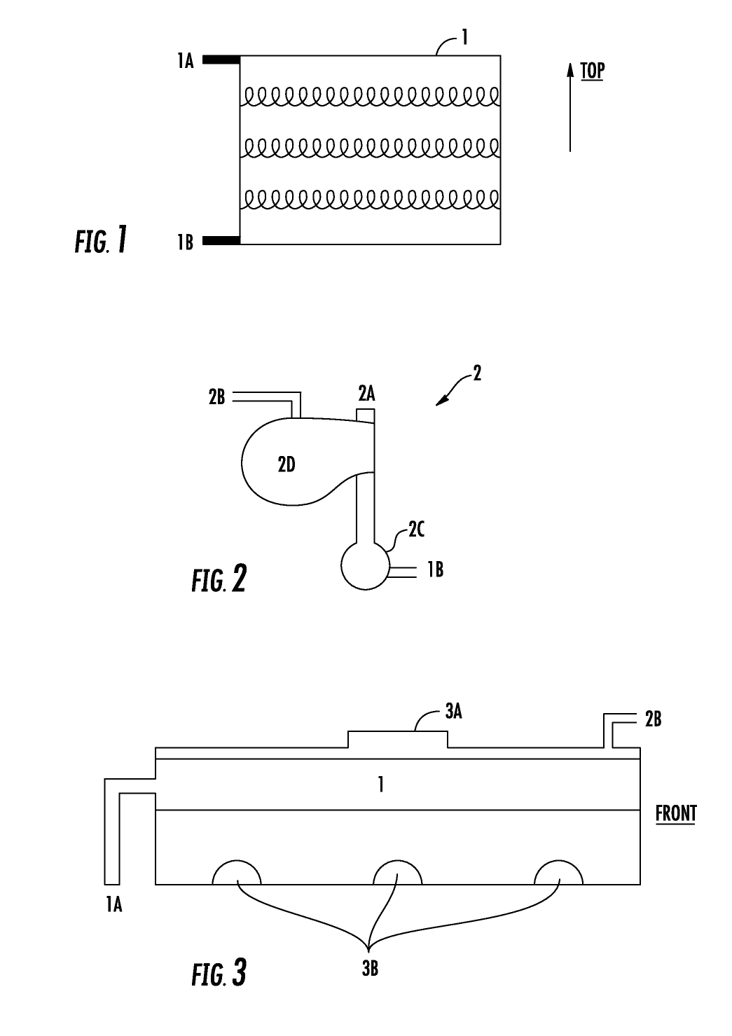

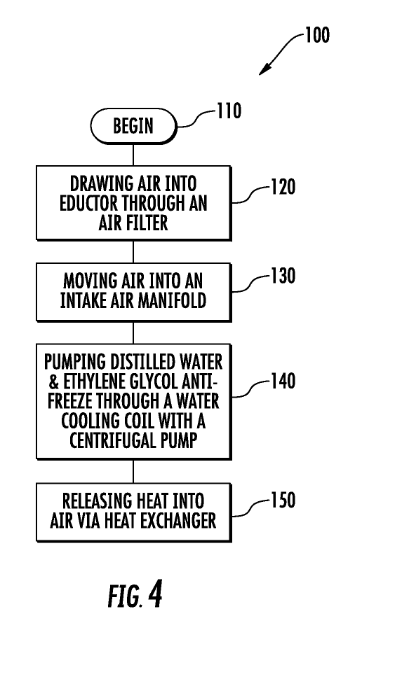

FIG. 1 is a perspective view of a hydronic water cooling coil, according to an aspect of the present disclosure. As illustrated, the hydronic water cooling coil 1 has a port 1A leading to the air intake manifold 3 and a port 1B coming from the centrifugal pump 2. The hydronic water cooling coil 1 may be mounted to the radiator of a vehicle. A vehicle is preferably a mobile vehicle such as a motorcycle, car, truck, recreational vehicle (RV), boat, plane, moped, and so forth. The hydronic water cooling coil 1 may be contained inside the air intake manifold 3 (as shown in FIG. 3). The placing of the water cooling coil 1 inside of the air intake manifold 3 will cause a change in pressure corresponding to the temperature, leading to a larger volume of air being introduced into the piston cylinder. The length and width will depend on the size of the vehicle. However, the greater the width of the coil (the width being the distance the air travels through the coil), the greater the cooling rate efficiency. According to one embodiment, the hydronic water cooling coil may have a length of 29″, a width of 5″ and a thickness of 3″.

FIG. 2 is a perspective view of a centrifugal pump used in the air intake system, according to an aspect of the present disclosure. As illustrated, the centrifugal pump 2 has a port 1B to the water cooling coil 1, a port 2A connected to its reservoir 2D and a port 2B from the air intake manifold 3. The centrifugal pump is driven by a belt 2C. A combination of distilled water and ethylene glycol (“chillwater”) is placed into the reservoir from port 2A. The chillwater travels into the centrifugal pump 2 and exits the centrifugal pump 2 at port 1B for travel toward the water cooling coil 1. A recirculating line may be attached to the port 1B of the centrifugal pump 2. The recirculating line may have a valve that may open to decrease the chillwater flow and pressure and may close to increase chillwater flow and pressure.

FIG. 3 is a perspective view of the air intake manifold containing the hydronic water cooling coil, and various ports to cylinders of the engine. As the chillwater exits the centrifugal pump 2, it makes its way to the hydronic water cooling coil 1 through port 1B. After the chillwater makes its way through the hydronic water cooling coil 1, it returns to the reservoir 2D through the port 2B of the air intake manifold 3. An air input port 3A may be configured to the top of the manifold 3 itself. This is the same input port that may be attached to an eductor. The other air ports 3B are attached to the piston cylinders. The air intake manifold 3 may have tubing that may be comprised of copper. The air intake manifold 3 may also have fins. The fins may be comprised of aluminum, steel alloy or combinations thereof.

In FIG. 4, a flow diagram of a method for cooling charged air prior to entering one or more cylinders of a diesel engine is shown, according to an aspect of the present disclosure. Method 100 may begin 110 by the ignition of the vehicle. Air is drawn 120 into an eductor through an air filter. An eductor takes the place of a turbocharger to provide the air flow. The eductor is a device that uses a small amount of air to move a larger amount of air by causing a change in pressure. An eductor allows a larger volume of air to be moved into the cylinders with less pressure, which leads to less heat within the system. It may be placed on the exhaust system to help draw the exhaust out of the engine in a y-shaped configuration. The y-shaped arrangement means that all air introduced into the system is filtered. In another embodiment, a turbocharger may be used instead of an eductor, e.g., in a shorter-stroke, higher speed diesel engine. In another embodiment, the eductor may have a regulator air valve connected to the engine fuel control that controls air flow. Air is then moved 130 into an air intake manifold. In another embodiment, air may be moved into an air-to-air cooler. A proportional mixture of distilled water and ethylene glycol antifreeze then absorbs heat. The mixture is then pumped 140 through the water cooling coil with a centrifugal pump. The mixture is located in a reservoir operably connected to the centrifugal pump. In another embodiment, the air may pass through an expansion chamber mounted to a chillwater cooler, which then gets circulated by the centrifugal pump before introduction into the cylinders. Any additional heat is then released 150 into the air via a heat exchanger to cool charged air prior to entering one or more cylinders of a diesel engine. In one embodiment, the heat exchanger is a radiator. The heat exchanger may optionally be comprised of aluminum.

The diesel engine of the air intake system for cooling charged air must also be configured to allow for engine efficiency. The diesel engine's piston speed may be increased by elongating the crankshaft radius, causing the piston stroke to increase by twice the amount of radial distance increase in one revolution. The piston speed of the diesel engine on the piston's compression stroke is important to obtain ignition heat to combust the fuel, i.e., the faster the air is compressed, the higher the temperature to allow for fuel combustion. Therefore, the diesel engine has a larger displacement due to an increase in radial distance between a crankshaft center and a rod journal center. The larger the displacement means that the engine has the ability to perform more work. For example at 1000 RPMs, a 5″ bore (the bore being the diameter of the piston cylinder), 5″ radial distance and 10″ piston stroke gives a displacement of 196.25 per cylinder and a piston speed of 18.93 miles per hour; a 6″ bore, 6″ radial distance and 12″ piston stroke gives a displacement of 339.12 per cylinder and a piston speed of 22.72 miles per hour; and 7″ bore, 7″ radial distance and 14″ piston stroke gives a displacement of 538.51 per cylinder and a piston speed of 26.5 miles per hour. With this large displacement occurring per cycle, two, four, or six cylinders can be used. A two stroke or four stroke cycle may be used to implement these features.

In another embodiment, the displacement per cylinder causes the stroke of a plurality of pistons to double as the radial distance increases. For example, a 1″ radial distance corresponds to a 2″ piston stroke, a 2″ radial distance corresponds to a 4″ piston stroke and so forth. As described in the above examples, matching the crankshaft bore to the radial distance will determine the piston stroke.

In another embodiment, the increase in the stroke of the plurality of pistons allows a large volume of gases to enter the piston cylinder. This allowance of a large volume of gases into the cylinder raises the ignition temperature, which leads to a more efficient combustion of fuel. Optionally, the diesel engine will have a compression ratio of 20:1. The compression ratio may be determined by the amount of air that is in the cylinder during the compression piston stroke.

While the present disclosure has been particularly shown and described with reference to specific embodiments, it should be understood by those skilled in the art that various changes in form and detail may be made therein without departing from the spirit and scope of the disclosure as defined by the appended claims.

What is claimed is:

1. An air intake system for cooling charged air prior to entering one or more cylinders of a diesel engine, the system comprising:
a hydronic intake air manifold comprising tubing and fins having a pair of ports further comprising a hydronic water cooling coil having a pair of ports and a belt-driven centrifugal pump having a plurality of ports with a reservoir containing a proportional mixture of distilled water and ethylene glycol antifreeze.

2. The system of claim 1, wherein the hydronic intake air manifold has a pair of ports connected to the hydronic water cooling coil and the reservoir of the centrifugal pump.

3. The system of claim 1, wherein the hydronic water cooling coil has a pair of ports connected to the air intake manifold and the centrifugal pump.

4. The system of claim 1, wherein the belt-driven centrifugal pump has a plurality of ports connected to the water cooling coil, the reservoir of the centrifugal pump, and the intake air manifold.

5. The system of claim 1, wherein the hydronic intake air manifold tubing comprises copper.

6. The system of claim 1, wherein the hydronic intake air manifold fins comprise aluminum, steel alloy, or combinations thereof.

7. The system of claim 1, wherein the width of the coil determines cooling rate efficiency.

8. A vehicle comprising the system of claim 1.

9. An air intake method for cooling charged air prior to entering one or more cylinders of a diesel engine, the method comprising:
drawing air into an eductor through an air filter, wherein the eductor is coupled to the intake system;
moving air into an intake air manifold where a proportional mixture of distilled water and ethylene glycol antifreeze absorbs heat;
pumping mixture through a coil by a centrifugal pump, the mixture being located in a reservoir operably connected to the pump; and
releasing the heat into the air via a heat exchanger to cool charged air prior to entry to an intake port of one or more cylinders of a diesel engine.

10. The method of claim 9, wherein a regulator air valve controls air flow of the eductor, the regulator air valve being operably connected to a fuel control of the diesel engine.

11. The method of claim 10, wherein the eductor is coupled to the intake system in a y-shaped configuration.

12. The method of claim 9, wherein the heat exchanger is a radiator.

13. The method of claim 9, wherein the heat exchanger is comprised of aluminum.

14. A diesel engine used in the air intake system for cooling charged air, the diesel engine having a displacement due to a radial distance between a crankshaft center and a rod journal center.

15. The diesel engine of claim 14, wherein the displacement causes the stroke of a plurality of pistons to double as the radial distance increases.

16. The diesel engine of claim 15, wherein the matching of a cylinder bore to the radial distance determines the stroke.

17. The diesel engine of claim 16, wherein the increase in the stroke of the plurality of pistons allows a volume of gases to enter a cylinder.

18. The diesel engine of claim 17, wherein the allowance of a volume of gases into the cylinder raises the ignition temperature.

19. The diesel engine of claim 18, wherein the compression ratio is 20:1.

20. A vehicle comprising the diesel engine of claim 14.
